(19) United States
(12) Patent Application Publication
(10) Pub. No.: US 2017/0300647 A1
(43) Pub. Date: Oct. 19, 2017

(54) Health In Your Hands

(71) Applicants: Marc Daniel Goldberg, Charlottesville, VA (US); Deanna Bucklen Cash, Monroe, VA (US)

(72) Inventors: Marc Daniel Goldberg, Charlottesville, VA (US); Deanna Bucklen Cash, Monroe, VA (US)

(21) Appl. No.: 15/404,086

(22) Filed: Jan. 11, 2017

Related U.S. Application Data
(60) Provisional application No. 62/387,959, filed on Jan. 11, 2016.

(51) Int. Cl. G06F 19/00; G06N 5/04; G06N 99/00; G06F 19/18; G06Q 10/10

(52) U.S. Cl. CPC G06F 19/345; G06N 99/005; G06N 5/045; G06F 19/3456; G06F 19/322; G06F 19/3406; G06F 19/18; G06Q 10/109; G06F 19/363

(57) ABSTRACT

The invention in this application is a decision-support system that utilizes single system design (SSD) and a proprietary algorithm to determine real change is for each individual patient. It pinpoints right medication and dosage for an individual patient, targets standards for functionality, called Activities of Daily Living (ADLs), and Quality of Life Indicators (QoLIs) to maximize personal health and satisfaction. Further, the system has as hallmarks a specific communication system, provision of coordination of services and a continuum of care for seamless delivery of treatment targeted to the needs of an individual patient and his/her care network. It incorporates data collected from genomic testing, patient entry, and automated devices. It is a safety-enhancing, cost-saving, time-saving system that will address placebo effect. It will utilize a variety of technologies to gather data with flexibility for patient needs. It will utilize machine learning for added safety enhancement.

### CROSS REFERENCE TO RELATED APPLICATIONS

This application claims the benefit of PPA 62/387,959 by the present inventors, which is incorporated by reference.

### FEDERALLY SPONSORED RESEARCH

Nonapplicable

### SEQUENCE LISTING

Nonapplicabie

### BACKGROUND OF THE INVENTION

The invention (HiYH) detailed in this Patent Application has as its hallmark a single system design, within-patient data analysis system with a proprietary algorithm that revolutionizes our understanding of what real change is for each individual patient, rather than relying on a “one-size-fits most” approach so medical decision-making. The system detects outliers (change in symptoms, side effects, and quality of life indicators) AND determines the relationship between change and medication/dose for that individual patient. While the description of this invention found in this patent application describes a medical application, the decision-making system will be applicable to a wide variety of settings, including service industries and educational decision-making, as well as personal management and lifestyle enhancement. HiYH will also be useful for determining the degree to which an individual is experiencing placebo effect. HiYH will find the right drug that works in a particular patient's body and will have the capacity to determine, through SSD design, how much of the effect is due to placebo effect.

HiYH at its core, in our piloting, and certainly entirely through its early implementation is a Decision-Support System using individualized probability based statistics to detect true charge and causally link it to treatment. Our SSD components for inferentially detecting change for monitoring and for causally analyzing to what extent if any, that change can be attributable to a specific medication and dose and make changes accordingly. In the process of collecting and individually analyzing these ultra-repeated measures data, we will be determining what works for that individual and then be able to determine what are better starting points for others who present similarly (e.g., symptomatic clusters, genetics, etc.). This will establish new and evolving EBPs based on these aggregates of what worked at statistically significant levels for those groups of individuals. All of this is decision-support and the evidence will be easily and conveniently available to providers and reporting to third party payors to gain approval for changes from population approved treatments that are much less likely to fit the individual.

It is essential to distinguish between what will certainly gain acceptance as decision support from the machine-language (sometimes called Deep Learning or Neural Networks) analysis by which improved predictions (treatment choices) can be made by Artificial Intelligence which cannot easily be understood or explained even by or to the expert human decision-maker. For example, in mental health research, a computer can now diagnose depression and anxiety disorders reliably through listening to phone voice tone (frequencies) as well as analyzing pattern changes in the words in social meeting postings. We will be able to use these kinds of data (and HiYH will be generating and using in high frequency these kinds of data—one common QoLI is phone contact with a loved one. We will have people take snapshots of themselves which will show postural and facial patterns, videos which will show mobility issues). Through machine-learning techniques, these patterns will be analyzed and modeled and reliable change will be detected that indicate a diagnostic or real change. That there is some kind of unspecified change (relatively easy to accept “voice tone” as indicator of mood) and that it can be reliably detected if not described (there is a change in facial expression frequency or amplitude or mobility variables that could just as well be described as “a hitch in his giddy tip” will be more challenging to accept as a basis for prescriptive changes. Nonetheless, we will both gather and use these AI techniques to analyze and predict and the computer will eventually be telling us that a particular medication or dose is much more likely to work in individuals for whom we have a pattern that the human brain cannot truly perceive or put into accurate words. Further, the system will be able to analyze changes in mobility that will activate prior to a medical crisis being triggered. For example, a video camera on HiYH-provided technology will take video samples of the patient's movement at preset intervals. This information, like other automated data, will be analyzed continuously through the HiYH system until an outlier, representing significant change is triggered. At such a time, alerts to the patient and Circle of Care will be implemented to ensure the patient received any care needed. This has the potential to recognize not only when a patient has fallen but when medical events, such as strokes, are beginning, thus providing services early in the event before it reaches crisis level. Outcome research may eventually persuade doctors, patients, and payors that these improved outcomes justify an intervention change despite not being able to describe why. HiYH will generate that data and do those analyses and offer that augmentation to practice decisions.

With today's readily available technologies, an overabundance of data, medical and other types, is easily collected and made available. For example, we have the technology to take a measurement of a person's pulse every few seconds, and this ultra-repeated measurement generates what is known as “Big Data” very quickly. The challenge in working with this Big Data is that no system before HiYH has developed a method for repeatedly capturing it, generating a hypothesis (e.g., this medication improves this symptom) and testing it with scientific FDA-level rigor for that individual) then adding the rigor of resetting the baseline and continuing to monitor for significant change HiYH is the only system that will do this so that a patient (and his provider, family, anyone that the patient designates) can know with scientific certainty whether a particular medication or intervention works in her/his body in real-time. Plus, the HiYH system asks the patient to submit genomic testing (or provides it) and anonymously compiles this information and patient data for medications and side effects. This aggregated database will provide predictive data that increases the efficacy of prescriptions for an individual patient who fits certain demographic profile(s), thereby supporting physician decision-making with evidence-based individualized alternative. This is context for medical decision making and selection of appropriate medication.

Single System Design

One critical piece of this invention is the unique use of inferential statistics within an individual rather than the current standard that science uses across disciplines, the “p<0.05” standard that infers from a sample statistic and generalizes this to a population. This (p<0.05) is also the standard that the FDA uses to approve drugs for treatment of specific diseases. (Note: Inferential statistics differs from descriptive statistics, which simply state, or describe, something about samples. For example, in a study of diabetes, descriptive statistics may simply tell us that 25% of the treatment group is male and 30% of the control group is male; but descriptive statistics make no statements of probability that the percent of males in the sample means anything about the percent of males who have diabetes in the population. In contrast, the current standard that science uses for inferential statistics, the “p<0.05” standard, looks for statistically significant differences between treatment and control groups that are sufficiently large (relative to its variance within each group) to legitimately infer that this difference would be generalizable to the entire population of people with the given disease. For example, is the difference in lowering diastolic blood pressure by 10 mmHg between, two samples of patients with hypertension (one treated with an antihypertensive medication and the other an untreated control group) sufficiently large to have confidence that the particular medication's efficacy for lowering the diastolic blood pressure by 10 mmHg for the entire population of people with hypertension? (Note: this type of inferential generalization is simply saying that the 10 mmHg difference in the study means that there is less than a 1/20 chance that this difference between the control and treatment groups was due to chance, so we can say the medication works.)

Science has developed inferential statistics over a long history of recognizing the danger of False Negatives (believing that no change has occurred when true change has occurred) and False Positives (believing that a change has occurred when it truly has not). Minimizing the first is called sensitivity and minimizing the second is called specificity. The p<0.05 that we see reported as the scientific standard is an index of specificity (while statistical power, less often reported, offers some insight into a study's sensitivity). There are usually trade-offs in classic science in trying to maximize each of these virtues of a test or study (that is, the things that you can do to maximize sensitivity can lower specificity, and the converse is often true). In practice, depending on the course and consequence of an illness and the likelihood of success of conventional treatment or the “Standard of Care,” decisions about whether sensitivity should be prioritized (even at the cost of some specificity) make sense, but the structure of academic science does not create much space for such decisions. Publication in scientific journals or approval by the FDA for treatments are made primarily focused on specificity (p<0.05).

The virtue of SSD's inferential methodology is in being able to determine when statistical significance has been achieved so that real-time change will be captured and analyzed so that whenever true change occurs, actionable alerts will be triggered and all patient-chosen stakeholders will know. In other words, this invention dramatically maximizes sensitivity and timeliness of individualized, evidence-based practice while using the very inferential statistics that science has grown and the FDA has used for specificity. That is, when a doctor gets an alert, he will know that there is at least a 95% chance that real change has occurred, exactly when it occurred, and if he wants, he will he able to then look at the relevant parts of the data in graphical or tabular form to know exactly what happened and when. The frequency of the repeated measurements that has previously posed the problem of overwhelming our capacity to evaluate the data has (in this invention) been translated to our being able to replicate measurement (repeat an assessment of out of range values), ensuring safety when the data indicates significant negative change, and also when the decision to be made is not urgent, to replicate the results. Treating the results of an initial scientific study as the hypothesis for another study to replicate it is science's cutting edge methodology, pioneered through the Center for Open Science, and such studies are being published in premier scientific journals and cited or being funded by the National Science Foundation, the FDA, CDC, NIH.

In Single Subject Design, or Single System Design (SSD), many mathematically legitimate inferential statistics have been developed in recent years in various scientific fields. However, while they have often been used with systematic methodological rigor to make inference from very small samples (or individuals) to populations of interest, they have also been misused because of the simple non-statistical issue that there is often insufficient work done to ensure that the sample of 1 is legitimately representative of the population of individuals or systems for which we'd like to draw an inference. What is unique about the current invention is that it uses these scientifically legitimate SSD statistics only to be able to draw inference from one individual to that same individual.

Other Aspects of HiYH

This Patent Application relates to a decision-support system to improve the connection and flow of information between patients, healthcare providers, caregivers, and family members. It is a communication system tailored to the needs of the client while providing targeted, manageable data for service providers. The system incorporates a continuum of care/services, utilizing a computer-generated notification system and call center interface as a bridge between the client and all other stakeholders. As discussed above, the system uses within-patient, single system research design and innovative inferential statistics that adhere to rigorous statistical standards to inform timely, responsive, and effective decision-making.

In today's data-driven society, patients, families, and health professionals are bombarded with information so that even the most attentive, expert human brain is unable to process, analyze, and integrate information in a way that would make true sense of the information. In the age of wearable devices that provide continuous data, consumers pay only superficial attention to the information available to them from their devices, much less do they sift through the data to uncover patterns that may improve their overall functioning. Busy medical professionals have little time to look at data; often relying instead on computer generated interpretive reports. Further, many true medical changes are too subtle for even an expert human brain to discern from the excess of real-time data and busy medical professionals do not have the time to devote to processing and assessing patterns to identify true change.

Even in today's data-driven society, many service-based industries use decision processes based on client-recalled impressions, incomplete or tangential data, and/or the recall of the client. There is a wealth of scientific research demonstrating consistent and dramatically large retrospective recall biases across social and medical sciences. Our memory for minutes ago, let alone months (the typical standard of assessment), is profoundly biased by how we feel physically and mentally at the time the question is asked. These assessments are not the most effective of decision-making tools, resulting in decisions that increase personal and financial costs to consumers (and financial costs to companies that employ insure consumers as welt as those that provide services). These ill or untimely informed decisions decrease efficiency and effectiveness of healthcare delivery, and decrease client health and satisfaction with the service in question in the short and long-term. The invention described in this Patent Application eliminates retrospective bias, analyzing data collected automatically from an array of devices and short “moment” surveys. Doctors can make informed decisions based on these analyzed data rather than solely on what patients report from memory. This invention's proprietary algorithm, based on single system research design, determines when an individual patient's status has statistically varied from his or her individual baseline as the system measures and analyzes whether a medication works in an individual with scientific certainty in real time. Currently, appointments are scheduled arbitrarily and patients may feel they have limited access to their physicians when access is needed. The invention described in this application revolutionizes access to care. With HiYH doctors will know when a medication is working, when it is not, and when side effects are impactful without waiting for a scheduled appointment. Once part of the HiYH system, data is automatically sent to the doctor's office and may change the patient's previously assigned appointment. Further, if the patient needs care prior to the time of the appointment, fee care is coordinated: If appropriate, the patient will be referred to a telemedicine group, urgent care facility, or (when necessary) the emergency room. When this referral is made the patient's Circle of Care contacted, further enhancing the care received by the patient. For today's patients, recovery may be prolonged and may require several changes in medications (or the prescription of multiple medications), taking weeks, months, or even years for patients to experience substantial relief from symptoms. This medical decision-support system helps pinpoint the right medication and dosage quickly, identifies consequential side effects, and precisely informs patients, medical professionals, and other caregivers to significant change when it is time for informed action, thus reducing needless and stressful worsening of symptoms for patients that currently may lead to unnecessary and costly hospitalization and emergency room visits. Further, HiYH in hospital offers a different form of monitoring that will help even when the expensive hardware and highly trained personnel only available on an inpatient basis are required. The invention is, therefore, a safety-enhancing, health-optimizing, and cost-reducing system.

The system will include looking for interactions in existing medication databases whenever a new medication or supplement is added, flagging medications for refills and communicating with doctor's offices automatically (always with patient choosing these services). When a medication is not working at all (or is plateauing short of target values, providers will have a link to alternative doses, evidence-based practice, and alternative medications related to BOTH the medication used (similar FDA approved drugs for the diagnosis) or the symptoms. This will add efficacy and safety options in the event that the ineffective medication was being tried off-label or will give options for off-label uses that have evidence to support their utility for the specific symptoms. This system communicates only statistically significant information and only when information is relevant in real time to doctors and other health professionals, thereby drastically increasing the efficiency of the use of health care professionals' time. Further, this invention will provide tiered alerts to medical professionals and those family members and caregivers designated in advance by the patient, known in this system as the “Circle of Care.” In addition, to its statistical significance focus on sensitivity and specificity with biometric data, this invention also targets medical science and third party payor's practical standard of functionality: Activities of Daily Living (ADLs). To determine baseline functioning and prioritize improvement goals, patient and provider collaborate to choose relevant impaired ADLs and improvement goals as part of the system's emphasis on clinical significance. The problem-solving system designated in this Patent Application is a HIPAA compliant communication system with patient-selected family and caregiver notification, featuring seamless communication between patients and physicians through tiered use of trained medical and support professionals. The system also incorporates a continuum of care that provides interaction, between patient data and a computer generated notification system that, depending on the level of intervention needed, can contact a system provided call center, a caregiver/family member designated by the patient, a trained receptionist in the physician's office, a nurse in the physician's office, and/or the physician. Data collection is in the form of brief patient-reported survey and biometric data that is collected through automatic integration of device information, utilizing technology which is often wearable, affordable, and easily managed in a home setting. Triangulation of information from patient report, data collected from automated devices, and other medical tests increases the medical professional's confidence in medical decision-making. Data collection is tailored to the patient's needs and preferences for multi-directional information-sharing with designated family members and professionals, form(s) of data to enter, amount of data to enter, and technology used. The system also allows integration of existing technological applications, including medical interaction applications.

The system described in this Patent Application, quite simply, determines what works for the individual patient. Clinical significance in this system is defined as “what is meaningful to the patient.” Therefore, the system is truly patient-centered, having each patient chooses the symptoms that are disruptive to his/her life and helping the patient monitor, analyze, and report those symptoms immediately, and succinctly to their health-care provider. The invention in the current Patent Application provides real time data delivery into the system, continuous data analysis, system communication of any statistically significant information, only when information is relevant, to health providers, thereby drastically increasing the efficiency of the use of health care professionals' time. The system detects outliers (change in, symptoms, side effects, and quality of life indicators) AND determines the relationship between change and medication/dose for that individual patient. HiYH will also be useful for determining the degree to which an individual is experiencing placebo effect. Not only will HiYH find the right drug that works in a particular patient's body; it will also have the capacity to determine, through SSD design, to determine how much of that is due to placebo effect.

### Background—Prior Art

The following is a tabulation of some prior art that presently appears relevant;

US Patents

| Patent Number | Kind Code |
|---|---|
| U.S. Pat. No. 6,687,685 | B1 |
| U.S. Pat. No. 8,126,740 | B2 |
| U.S. Pat. No. 0,244,296 | A1 |
| U.S. Pat. No. 5,390,238 | |
| U.S. Pat. No. 5,434,611 | |
| U.S. Pat. No. 5,441,047 | |
| U.S. Pat. No. 7,761,312 | B2 |

Advances in technology over the past several years have brought about significant changes in medical diagnostic and monitoring equipment, with an increase in expectations for patient self-monitoring of chronic conditions. However, other systems fail to provide a support system for patients in that process, while the system described in this Patent Application both empowers each patient to take an active role in maximizing personal health and individual ownership of health care, while connecting family, caregivers, professionals and organizations into a cohesive health care team. Further, the system facilitates the aggregation of relevant research data that will inform and refine patient-specific medical decisions in the future. For the physician, this system efficiently deciphers layers of data, providing targeted information and context for efficient medical decision-making. For the health care organization, the system facilitates a culture of maximized health for individuals while transforming the health care system from subjective and reactive to responsively objective and proactive, thereby becoming effective and efficient Most attempts to monitor patients remotely have included the use of personal computers and moderns to establish communication between patients and healthcare providers. However, computers were too expensive to give away on a large scale prior to the cost saving health innovation system here. The patients who own and are already comfortable using the computers arc typically young, well educated, and have good healthcare coverage. Thus, these patients do not have the greatest unmet medical needs. The patients who have the greatest unmet medical needs are the poor and elderly who do not own computers or who are unfamiliar with their use. This system uses a variety of currently available technologies to gather and automatically transmit the data even in homes that have no internet or cellular service and can only communicate date by landline.

There is a recently approved patent (U.S. Pat. No. 6,687,685 B1) that describes using Bayesian Statistics, a technical term for improving the predictive value of a piece of conditional information (e.g., a person's race, or a genetic marker) and having that improve a provider's ability to predict whether a particular treatment will work for an individual. Bayesian statistics have been around for centuries and applying them to medical decision-making makes intuitive sense. However, the approved patent does not sufficiently specify how to gather the right data and what analyses to use to establish these known, improved conditional probabilities. This is because it is relying on relatively conventional population statistics which is what medicine (and business and many other decision-making domains) have been touting as the promise of Big Data. As of the end of 2016, the scientific studies that have reviewed the outcomes of medical Big Data-based interventions have shown very little efficacy. This is because they have relied on solely population statistics for decision-making and not the individualized inferential statistics employed through this invention. This lack of efficacy is further complicated by the slowness of conventional scientific and medical treatment models. Pre-post and placebo-controlled studies have tested people over intervals of many months or years and the treatment changes within the studies are based on medical interventions made at historical medical intervals (often 3 or more months). Even when individual data is reviewed as part of this treatment model, it is reviewed most often at the wrong time (not when symptoms have changed) and even the most attentive, expert human brain is unable to process, analyze, and integrate information in a way that would make true sense of the information, “Eyeballing” Big Data trends in real-time without inferential statistics to tell us when true change has occurred is a fallacy even if it were logistically possible.

Recent technological advances have yielded a plethora of medically related technological applications, and most medical offices use Electronic Health Records (EHRs) to manage basic patient data. However, to date these technologies are underutilized in terms of their use in improving medical decision-making, access of patients to their physicians, and patient experience and satisfaction with the medical process. For example, U.S. Pat. No. 8,126,740B2 describes a system “recording, storing, and accessing financial, clinical, and data/information case management services. The method includes collecting service data pertaining to a customer from a plurality of sources, storing the data, and providing multiple points of access to the data for retrieval by an individual via a user interface.” Further, this system allows for a decision-making system to operate independently, but in conjunction with, the system for the purposes of planning and managing collected data. The system does not, however, provide a method for specifying or analyzing the “Big Data” (based on within-individual statistics), alerting, and communicating to stakeholders that is essential to effective, timely decision-support, which is included in the invention embodied in this Patent Application. The current invention's alerting system will allow Circle of Care members to be up to date and to be able to seamlessly hand off who is taking point as the family support that day (or that hour on a call or taking a parent to a doc visit when they haven't seen them all week), or in advocating/collaborating with the medical systems and caretaking systems. The schedule of caregivers expected to be in the home as well as the out of home medical and life appointments (patient's personal calendar if they wish, including visiting church, social activities, etc. ). Circle of Care members will have the capacity to enter notes of appointments or events that can have custom privacy settings (e.g., standard communication about symptoms, etc. would include all of the caregivers access, a custom sibling group could allow updates on communications with insurance, subgroups of siblings, the administration of an in-home caretaker company about scheduling or concerns/questions related to performance of specific caregivers—often weekend caregivers are new and are being evaluated by patient and family.

U.S. Pat. No. 0,244,296A1 presents a computer-implemented method that includes software and systems for “controlling the distribution of medical care applications that interface with an analytical infrastructure” wish the intent of facilitating medical decision-making and utilizing hand-held technology, such as a cell phone, to simplify the process for users. This system, gathers information from a retail pharmacy, patient, prescriber and pharmaceutical company to record, and manage a history of prescribed medications and to alert stakeholders to dangerous medication interactions, maintaining aggregate data for physicians to access and interpret. However, the system, does not offer an interpretive system specific for the individual person's response to medication. Further the system provides an overwhelming amount of data, decreasing the likelihood that the data will be utilized with reliability and validity by busy health care professionals, as it would require dedicated hours per patient to review and adequately interpret the data recorded. However, this system does provide a medical decision-making module, based on comparison of patient data to existing aggregated data, and makes recommendations to the patient about subsequent steps, including whether or not to make a follow-up medication appointment. Yet, this system does not analyze the patient's data in relation to his/her own data patterns and history, nor does it provide automatic interaction with medical care professionals to follow-up with the patient, gather additional information, and refine the decision-making process, based on that individual patient's needs. This system also provides a smart phone application for patients to use in monitoring health data, including medication reminders, checking for drug interactions, and ordering prescription refills. Further, the application allows access to existing applications for generically tracking and managing certain health conditions, such as asthma or multiple sclerosis. However, these interfaces do not integrate the individual patient's data into a decision-making process, as does the system described in the current Patent Application.

Previous inventions to monitor patients remotely have included the use of interactive telephone or video response systems (e.g., U.S. Pat. No. 5,390,238, U.S. Pat. No. 5,434,611, U.S. Pat. No. 5,441,047). These systems have required patients to access a call center for data monitoring for the call center to call the patient according to an inflexible monitoring schedule, raising concerns of patient compliance or patients waiting until an emergency situation to contact the system or health-care provider. Further, calls from a call center are disruptive to a patient's life and are likely to increases resistance to the system. The invention embodied in this Patent Application utilizes technology to minimize the disruption of the patient's life with redundancies in place to ensure compliance with the patient's desired and required input. Most data will be automatically transmitted, using wearable or portable devices provided by the system. Further, the patient controls the configuration of the redundancies, selecting which work best for his/her lifestyle and resources. Per U.S. Pat. No. 7,761,312B2, the invention in question provides a system for healthcare maintenance that allows two-way communication between the patient and health provider, using a small handheld microprocessor-based unit that functions much like a hand-held gaming system, allowing a patient to use the device with a program cartridge targeting his/her medical condition. Communication between the data management unit and the handheld unit is established by an interface cable with a second interface cable to establish communication between the data management unit and a monitoring unit. In its preferred embodiment, the system also includes at least one monitoring device to measure a physiological condition. Standardized reports are provided to a healthcare provider by means of facsimile machine (FAX), using a modem that allows test results and other data stored in the system memory to be transmitted to a remote clearinghouse via a telephone connection. Data processing then may perform any required analysis, format the standardized reports, and transmit the reports to the FAX machine of the appropriate healthcare professional. The clearinghouse also allows information, such as changes in medication dosage, to be sent to a patient via telephone connection and the data, management unit modem. The invention also provides for memory storage of patient information, and it allows the healthcare provider to communicate with the clearinghouse via computer. This invention also allows for the use of several forms of display, such as a television or video display, as well as a variety of forms of microprocessor units, including “palm top” computers.

The system outlined in U.S. Pat. No. 7,761,312B2 shares similarities with the invention embodied in this Patent Application with a number of distinctive differences. The aforementioned system provides two-way communication between a patient and healthcare provider that is transferred on a set schedule, subsequent data processing, and reports sent to the health care provider, who may then communicate back through system with the patient the next time the patient accesses the system. The invention in the current Patent Application provides real time data delivery into the system, continuous data analysis, system communication of any statistically significant information, only when information is relevant, to health providers, thereby drastically increasing the efficiency of the use of health care professionals' time. Further, this invention will provide tiered alerts for a continuum of care not only to medical professionals but also to those family members and caregivers designated in advance by the patient, known in this system as the “Circle of Care.” The system in U.S. Pat. No. 7,761,312B2 uses a hand-held game-system-like device for patient data entry, with software related to a particular medical condition contained in a program cartridge inserted into the device, and separate physiological monitoring devices that must be connected by cable to the modem for communication with the data system. The invention in the current Patent Application utilizes smartphones in its preferred embodiment for seamless delivery of data from wearable and other portable devices, but it also allows for maximum flexibility for the patient based on his/her preferences and skills. For example, some patients may prefer use of a landline; therefore this system will provide Bluetooth enabled phones for patients in that instance. Other options include computer or tablet interface, and interactive television interface, and regular cellular phones. This system will utilize WiFi and cellular transmission of data, provided by the system after negotiation of contracts with major providers for this service, thereby making the current invention more accessible for patients without health insurance and those without internet capabilities in their homes. Use of these technologies allows immediate response and feedback when it is needed and provides seamless access to care. The system in U.S. Pat. No. 7,761,312B2 uses a data analysts system that is based on population data regarding analysis of symptoms. The current invention includes population, data for known definitions of clinically problematic standards meriting alert (e.g., hyper- or hypotension, bradycardia, tachycardia atrial fibrillation) and keeps some of them at the provider's discretion even after the data from the individual establishes different norms and patterns for the individual as described below. For example, even if it is a common pattern for the patient to have very low blood pressure (hypotension) and slow heart rate (bradycardia), and the sensitivity of the current invention to change, when those cardiac symptoms rise but are considerably short of population standards is unique and essential, there may be actionable changes based on population standards worth keeping in the alerting system. This patient, doctor, caregiver may still want to know when a relatively common event of bradycardia (by population standards) is occurring to be aware of it for safety reasons (not trying to stand up without support), PRN medications, non-pharmacological supplements, dietary choices. In other words, even if a non-standard variance in biometrics is actually standard for the patient, some population standards establish safety risks or actionable moments, even when common for that individual. Examples of dangers of high variability frequently ranging into high biometrics which are actionable also exist and actions are at the doctor and Circle of Care's plan and discretion (e.g., relatively brief periods of severe hypertension could be common but merit a shorter acting intervention, to prevent stroke or other risks).

However, one essential uniqueness of this invention is that it also utilizes single system design for within-patient analysis and the use of innovative inferential statistics, adhering to rigorous statistical standards (p<0.05) to inform timely, responsive, effective medical decision-making about what works for an individual patient. This allows for decision support to refine medications and dosages targeted to the needs of the patient, monitoring of statistically and clinically significant change in symptoms, and monitoring of side effects, creating a safety enhancing support system. Further, since it only alerts health providers when significant change indicates it is necessary, it is a time-saving efficiency-maximizing system for those providers This system pinpoints the right medication and dosage quickly, identifies and addresses consequential side effects rapidly, and precisely informs patterns, medical professionals, and other caregivers about significant change when it is time for informed action, thus reducing needless and stressful worsening of symptoms for patients that currently may lead to unnecessary and costly hospitalization and emergency room visits. These factors, plus the use of continuous monitoring, tiered alerts, and intervention prior to the patient being in crisis lead to the system also manifesting dramatic cost savings. The system in U.S. Pat. No. 7,761,312B2 offers patients the ability to monitor quality of life factors. However, the currently described invention assists the patient in identifying Activities of Daily Living (ADLs) that are impaired due to their current condition. These ADLs may stand in the way of improvement in the patient's medical condition and affect quality of life. Targets for improvement are set and analysed continuously, using the same statistical processes as medical symptoms. Further, patients are also prompted to select Quality of Life Indices (QoLIs) which may be completely unrelated to standard ADLs, and set targets for those, offering motivational reinforcement to patients. QoLIs are also analyzed using the same statistical processes as medical symptoms.

### OBJECTS AND ADVANTAGES OF THE INVENTION

The object of the invention (HiYH) detailed in this Patent Application is a decision support system using a single system design, within-patient data analysis system with a proprietory algorithm that revolutionizes our understanding of what real change is for each individual patient. The system detects outliers (change in symptoms, side effects, and quality of life indicators) AND determines the relationship between change and medication/dose for that individual patient. HiYH will also be useful for determining the degree to which an individual is experiencing placebo effect. Not only will HiYH find the right drug that works in a particular patient's body; it will also have the capacity to determine, through SSD design, to determine how much of that is due to placebo effect. HiYH first learns the definition of normal for each patient and only creates alerts if there is a statistically significant change from those parameters, regardless of population-based standards. The medical decision-support system embodied herein helps pinpoint the right medication and dosage quickly, identifies consequential side effects, and precisely informs patients, medical professionals, and other caregivers to significant change when it is time for informed action, reducing needless and stressful worsening of symptoms for patients that currently may lead to unnecessary and costly hospitalization and emergency room visits. Further, HiYH in hospital offers a different form of monitoring that will help even when the expensive hardware and highly trained personnel only available on an inpatient basis are required. For example, as an inpatient HiYH would have alerted nursing station that a bag change was overlooked and sepsis would have been prevented. While many very unstable people will actually be better monitored and treated at home on HiYH than at hospital without it, inpatient HiYH will bridge that gap and create a new level of sensitivity and efficiency for intensive inpatient care when needed.

This invention revolutionizes access to care by connecting the patient, designated caregivers and family members, and health providers whenever there is statistically or clinically significant change rather than waiting for an arbitrarily-scheduled follow-up appointment. Once part of the HiYH system, data is automatically sent to the doctor's office and may change the patient's previously assigned, appointment. Further, if the patient needs care prior to the time of the appointment, the care is coordinated: If appropriate, the patient will be referred to a telemedicine group, urgent care facility, or (when necessary) the emergency room. When this referral is made, the patient's Circle of Care is contacted, further enhancing the care received by the patient. In addition with HiYH, doctors will know when a medication is working, when it is not, and when side effects are impactful without waiting for a scheduled appointment. Yet, HiYH drastically maximizes efficiency of health providers by communicating only statistically significant information and only when information is relevant in real time. These factors combined render this invention a safety-enhancing, health-optimizing, and cost-reducing system. It is also a communication system tailored to the needs of the patient, as it will provide tiered alerts to medical professionals and those family members and caregivers designated in advance by the patient, known in this system as the “Circle of Care.” The system incorporates a continuum of care/services that provides interaction between patient data and a computer generated notification system that, depending on the level of intervention needed can contact a system provided call center, a caregiver/family member designated by the patient, a trained receptionist in the physician's office, a nurse in the physician's office, and/or the physician. Data collection is in the form of brief patient-reported survey and biometric data that is collected through automatic integration of device information, utilizing technology which is often wearable, affordable, and easily managed in a home setting. This system uses a variety of currently available technologies to gather and automatically transmit the data even in homes that have no internet, or cellular service, and can only communicate data by landline; thus it provides much-needed services to the poor and elderly, who have the greatest unmet medical needs. Data collection is tailored to the patient's needs and preferences for multi-directional information-sharing with designated family members and professionals, form(s) of data to enter, amount of data to enter, and technology used. The system also allows integration of existing technological applications, including medical interaction applications. Triangulation of information from patient report, data collected from automated devices, and other medical tests increases the medical professional's confidence in medical decision-making. The invention described in this Patent Application eliminates retrospective bias, analyzing data collected automatically from an array of devices and short “moment”0 surveys. Doctors can make informed decisions based on these analyzed data rather than solely on what, patients report foam memory. In addition, to its statistical significance focus on sensitivity and specificity with biometric data, this invention also targets medical science arid third party payor's practical standard of functionality: Activities of Daily Living (ADLs). To determine baseline functioning and prioritize improvement goals, patient and provider collaborate to choose relevant impaired ADLs and improvement goals as part of the system's emphasis on clinical significance. Plus, the HiYH system asks the patient to submit genomic testing (or provides it) and anonymously compiles this information and patient data for medications and side effects. This aggregated database will provide predictive data that increases the efficacy of prescriptions for an individual patient who fits certain demographic profile(s), thereby supporting physician decision-making with evidence-based individualized alternative. This is context for medical decision making and selection of appropriate medication. Such an aggregated database has far-reaching implications for determining how a variety of factors (physical, genomic, personality-based, and preference-related, among others) may impact which medication will work best for an individual.

### SUMMARY OF THE EMBODIMENTS

The invention embodied in this Patent Application. HiYH (for Health in Your Hands) is a single system design, within-patient data analysis system with a proprietary algorithm feat revolutionizes our understanding of what real change is for each individual patient rather than relying on a “one-size-fits most” approach to medical decision-making. The system detects outliers (change in symptoms, side effects, and quality of life indicators) AND determines the relationship between change and meditation dose for that individual patient. HiYH will also be useful for determining the degree to which an individual is experiencing placebo effect. Not only will HiYH find the right drug that works in a particular patient's body; it will also have the capacity to determine, through SSD design, to determine how much of that is due to placebo effect. HiYH has developed a system for repeatedly capturing Big Data, generating a hypothesis (e.g., this medication improves this symptom) and testing it with scientific FDA-level rigor for that individual (p<0.05) then, adding the rigor of resetting the baseline and continuing to monitor for significant change, HiYH is the only system that will do this so that a patient (and his provider, family, anyone that the patient wants to know) can know with scientific certainty whether a particular medication or intervention works in her/his body in real-time. Plus, the HiYH system asks the patient to submit genomic testing (or provides it) and anonymously compiles this information and patient data for medications and side effects. This aggregated database will provide predictive data that increases the efficacy of prescriptions for an individual patient who fits certain demographic profile(s), thereby supporting physician decision-making with evidence-based individualized alternative. This is context for medical decision making and selection of appropriate medication. What is unique about the current invention is that it uses these scientifically legitimate SSD statistics only to be able to draw inference from one individual to that same individual, this inferential methodology is in being able to determine when statistical significance has been achieved so that real-time change will be captured and analyzed, so that, whenever true change occurs, actionable alerts will be triggered and all patient-chosen stakeholder will know. In other words, this invention dramatically maximizes sensitivity and timeliness of individualized, evidence-based practice while using the very inferential statistics that science has grown and the FDA has used for specificity. HiYH is a decision-support system to improve the connection and flow of information between patients, healthcare providers, caregivers, and family members. It is a communication system tailored to the needs of the client while providing targeted, manageable data for service providers. The system incorporates a continuum of care/services, utilizing a computer-generated notification system and call center interface as a bridge between the client and ail other stakeholders. Data collection is in the form of brief patient-reported survey and biometric data that is collected through automatic integration of device information, utilizing technology which is often wearable, affordable, and easily managed in a home setting and cumulating retrospective bias. The frequency of the repeated measurements that has previously posed the problem of overwhelming our capacity to evaluate the data has (in this invention) been translated to our being able to replicate measurement (repeat an assessment of out of range values), ensuring safety when the date indicates significant negative change, and also when the decision to be made is not urgent, to replicate the results. Treating the results of an initial scientific study as the hypothesis for another study to replicate it is science's cutting edge methodology being funded by the National Science Foundation, the FDA, CDC, and NIH. Data collection is tailored to the patient's needs and preferences for multi-directional information-sharing with designated family members and professionals, form(s) of data to enter, amount of data to enter, and technology used. The system also allows integration of existing technological applications, including medical interaction applications. Triangulation of information from patient report, data collected from automated devices, and other medical tests increases the medical professional's confidence in medical decision-making. The system revolutionizes access to care. With HiYH doctors will know when a medication is working, when it is not, and when side effects are impactful without waiting for a scheduled appointment. Once part of the HiYH system, data is automatically sent to the doctor's office and may change the patient's previously assigned appointment. Further if the patient needs care prior to the time of the appointment, the care is coordinated: If appropriate, the patient will be referred to a telemedicine group, urgent care facility, or (when necessary) the emergency room. When this referral is made the patient's Circle of Care contacted, further enhancing the care received by the patient. This medical decision-support system helps pinpoint, the right medication and dosage quickly, identifies consequential side effects, and precisely informs patients, medical professionals, and other caregivers to significant change when it is time for informed action, thus reducing needless and stressful worsening of symptoms for patients that currently may lead to unnecessary and costly hospitalization and emergency room visits. Further, HiYH in hospital offers a different form of monitoring that will help even when the expensive hardware and highly trained personnel only available on an inpatient basis are required. The invention is, therefore, a safety enhancing, health-optimizing, and cost-reducing system. The system will include looking for interactions in existing medication databases whenever a new medication or supplement is added, flagging medications for refills and communicating with doctor's offices automatically (always with patient choosing these services). When a medication is not working at all (or is plateauing short of target values, providers will have a link to alternative doses, evidence-based practice, and alternative medications related to BOTH the medication used (similar FDA approved drugs for the diagnosis) or the symptoms. This will add efficacy and safety options in the event that the ineffective medication was being tried off-label or will give options for off-label uses that have evidence to support their utility for the specific symptoms. This invention will provide tiered alerts to medical professionals and those family members and caregivers designated in advance by the patient, known in this system as the “Circle of Care.” In addition, to its statistical significance focus on sensitivity and specificity with biometric data, this invention also targets medical science and third party payor's practical standard of functionality: Activities of Daily Living (ADLs). To determine baseline functioning and prioritize improvement goals, patient and provider collaborate to choose relevant impaired ADLs and improvement goals as part of the system's emphasis on clinical significance. The problem-solving system designated in this Patent Application is a HIPAA compliant communication system with patient-selected family and caregiver notification, featuring seamless communication between patients and physicians through tiered use of trained medical and support professionals. The system also incorporates a continuum of care that provides interaction between patient data and a computer generated notification system that, depending on the level of intervention needed, can-contact a system provided call center, a caregiver/family member designated by the patient, a trained receptionist in the physician's office, a nurse in the physician's office, and/or the physician. Data collection is in the form of brief patient-reported survey and biometric data that is collected through automatic integration of device information, utilizing technology which is often wearable, affordable, and easily managed in a home setting. Data collection is tailored to the patient's needs and preferences for multi-directional information-sharing with designated family members and professionals, form(s) of data to enter, amount of data to enter, and technology used. The system also allows integration of existing technological applications, including medical interaction applications. Triangulation of information from patient report, data collected from automated devices, arid other medical, tests increases the medical professional's confidence in medical decision-making. The system provides real time data delivery into the system, continuous data analysis, and system communication of any statistically significant information, only when information is relevant, to health providers, thereby drastically increasing the efficiency of the use of health care professionals' time. It utilizes smartphones in its preferred embodiment for seamless delivery of data from wearable and other portable devices, but it also allows for maximum flexibility for the patient based on his/her preferences and skills. For example, some patients may prefer use of a landline; therefore this system will provide Bluetooth enabled phones for patients in that instance. Other options include computer or tablet interface, and interactive television interface, and regular cellular phones. This system will utilize WiFi and cellular transmission of data, provided by the system after negotiation of contracts with major providers for this service, thereby making the current invention more accessible for patients without health insurance and those without internet capabilities in their homes. Use of these technologies allows immediate response and feedback when it is needed and provides seamless access to care.

One critical piece of this invention is the unique use of inferential statistics within an individual rather than the current standard that science uses across disciplines, the “p<0.05” standard that infers from a sample statistic and generalizes this to a population. This (p<0.05) is also the standard that the FDA uses to approve-drugs for treatment of specific diseases. ( Note: inferential statistics differs from descriptive statistics, which simply state, or describe, something about samples. For example, in a study of diabetes descriptive statistics may simply tell us that 25% of the treatment group is male and 30% of the control group is male, but descriptive statistics make no statements of probability that the percent of males in the sample means anything about the percent of males who have diabetes in the population. In contrast, the current standard that science uses for inferential statistics uses, the “p<0.05” standard, looks for statistically significant differences between treatment and control groups that are sufficiently large relative to its variance within each group to legitimately infer that this difference would be generalizable to the entire population of people with the given disease. For example, is the difference in lowering diastolic blood pressure by 10 points between two samples of patients with hypertension (one treated with an antihypertensive medication and the other an untreated control group) sufficiently large to suggest the particular medication's efficacy for lowering the diastolic blood pressure by 10 points for the entire population of people wife hypertension? (Note: this type of inferential generalization is simply saying that the 10 mmHg difference in the study means that there is less than a 1/20 chance that this difference between the control and treatment groups was due to change, so we can say the medication works.)

Thus, the invention embodied in this Patent Application differs from other products in that it analyzes the deluge of information, is sensitive to even subtle, but significant, change, offers specificity in what works medically, for whom, and under what circumstances, in addition, HiYH first learns the definition of normal for each patient and only creates alerts if there is a statistical change from those parameters, regardless of population-based standards. In this way, the invention prevents false positives and eliminates alert fatigue. The invention also eliminates false negatives by recognizing variation from normal for each patient well before a system that uses population data. Thus, this invention allows the patient, family, caregiver, and/or medical professional to take action before a small problem becomes a medical crisis

In essence, for the physician, this system facilitates delivery of medical care to patients that is timely, sensitive to the patient's preferences, and effectively tuned to the needs of each patient for efficient, optimized medical care. It also provides assistance in optimizing medical care, acting as an “assistant to the expert” system that signals the physician to look at data that are statistically significant so they can best determine what is clinically significant, as determined by the range of possible interventions. For third party payors, this system will improve patient care, enhance patient wellness, and increase patient satisfaction with their medical providers and system. It will also dramatically reduce costs through efficient tiered contact for the patient with medical system interaction, minimized ER visits and hospitalizations (while facilitating them when appropriate), targeted prescribing information, and efficiency in scheduling medical appointments when medically relevant, necessary, and effective.

While many medically-related technological applications exist and most medical offices use electronic health records to some degree, to date no comprehensive care-enhancing, system exists that includes the aspects described, above, and in the “CLAIMS” section, below.

### BRIEF DESCRIPTION OF FIGURES

FIG. 1. Patient calls to schedule appointment
1.1 is given an appointment
1.2 HiYH protocol (case) initiated
   1.2.1. Patient selects interactive interface
   1.2.2. Patient's individualized questionnaire is developed
      1.2.2.a. Patient prioritizes symptoms.
      1.2.2.b. Automatic monitoring devices are selected and shipment arranged
   1.3. Notifications set up
      1.3.1. Selection of schedule of notifications
         1.3.1.a. Time selection
         1.3.1.b. Selection of delivery method of notifications;
         3.1.1.c. Selection of Circle of Care participants;
   1.4. Medications entered
   1.5 Quality of Life index selected

FIG. 2. Initial Monitoring of Symptoms for statistical significance
2.1. Analyzing response to medication and dose, including side effects
2.2. Analyzing variability for outliers to identify real statistically significant change
2.3. Prompting medically appropriate follow-up if symptoms are at a critical level

FIG. 3. Initial Doctor's Visit
3.1. Patient receives reminders from HIYH about the appointment
3.2. Doctor review of existing HiYH data
3.3. Receptionist initial contact; patient signs release form, answers additional questions triggered by HiYH system or doctor, provides training and assistance as needed
3.4. Initial meeting with nurse; calibration of technology, answers questions about technology, verifies existing data, enters current data from initial exam
3.5. Doctor intervention: reviews information, sets symptoms targets with patient, submits prescriptions electronically, if needed.
3.6. Designee at doctor's office enters any additional pertinent information into HiYH system

FIG. 4. Ongoing Monitoring of Statistically and Clinically Significant Changes in Symptoms
4.1. Automated data continues to be entered in system automatically
4.2. Patient ratings for ADLs
4.3. Statistical analysis of automated data and patient responses continues and includes a protocol when statistically significant change is noted, protocol for improvement but no significant change, and protocol if no clinically significant change.

FIG. 5. Aggregated database

### DETAILED DESCRIPTION OF DRAWINGS

### Reflecting a Medical System Application of the Problem-Solving System

FIG. 1. Patient calls to schedule appointment; 1.1 is given an appointment; 1.2 HiYH protocol (case) initiated. Patient is provided a brief description: “HiYH is the system we use to put your Health in Your Hands through monitoring of your health and scientific determination of whether the treatment we determine together works IN YOUR BODY.” 1.2.a. Patient selects interactive interface. If the patient selects the interactive computer interface s/he will be provided a link to the webpage and instructed to sign on and complete the interview questionnaire within 24 hours. If the patient does not log on during this 24 hour period, an HiYH technician (calls the patient to complete the interview. If the patient logs on but does not complete the entire questionnaire, she will receive email and app reminders, if they are not responded to, they will receive a call from an HIYH trained technician, most often from the physician's office emphasizing that the appointment made requires this assessment of their symptoms and care needs. 1.2.b. Patient's individualized questionnaire is developed. The questionnaire will address: symptoms the patient currently experiences, Activities of Daily Living they are currently impaired from completing (ADLs), medications the patient takes (prescribed, over-the-counter, vitamins, herbal remedies, etc.), and behavior(s) (e.g., exercise, diet) that would improve the patient's quality of life (i.e., their own defined Quality of Life index-QOLI). 1.2.b.1. Patient prioritizes symptoms. Symptoms will be presented in a drop-down menu format with the patient asked to select all those symptoms s/he currently experiences. The patient will then be asked to prioritize the symptoms that most significantly disrupt his/her life at present (i.e., rank them in terms of interference with their functioning). All the other symptoms endorsed will be recorded in the system for future reference. Patient will later have the opportunity to add additional target symptoms once s/he is familiar with the system as soon as they are able to reliably use the system for their highest priority symptoms (default is beginning with the first three, but they may request customization if needed). 1.2.b.2. Automatic mom forms devices are selected and shipment arranged. For symptoms (e.g. blood pressure, heart rate, blood glucose, A1C, blood 02. mobility. EKG, weight, and consequent measurement above ankle for Congestive Heart Failure water retention etc.) that can be measured using FDA approved wearable or home technological devices, HIYH will arrange for shipment of appropriate devices to the patient (these devices are already typically covered in the Durable Medical Equipment components of most third party payor plans, HiYH will obtain pre-approval if necessary and inform patient of any potential costs to them which will be typically none or minimal since HiYH is partnering with the most reliable of these device manufacturers; HIYH will receive delivery confirmation for the device(s). Instructions for using the devices will be provided to the patient in the shipping material, as will the contact information for technical support through HIYH. The patient will be instructed to activate the device within 24 hours of receipt. If the patient does not activate the device within this time limit, s/he will receive a call from an HIYH-trained technician. Devices, once activated, will automatically collect data for the symptoms they target without the patient needing to take further action. 1.3. Notifications set up. For symptoms that are not addressed by a device (e.g. pain level), the patient will begin to receive notifications to respond to a series of 3-5 questions about the symptom(s) in questions. The patient will be able to tailor the notifications to his/her resources and needs by responding to interview questions regarding; 1.3.1. Selection of schedule of notifications; 1.3.1.a. Time selection. The patient will determine at what time of day s/he would like to receive notifications to complete the daily data collection questions and how often during the day to receive them, and the frequency of reminders when patient has failed to respond before s/he received a call from an HXYB-trained technician; 1.3.1.b. Selection of delivery method of notifications: Bluetooth enabled Landline or Smart Tv Interface (these “Nano-computers” cost about $50 and can transmit through landline if no other faster tech is available as well as travel with patient and transmit when hit a bluetooth, or Wi-Fi connection and connect through hdmi to any modem tv—allows automatic transmission of data from wearables and other devices provided to patient by HIYH; for other data, patient receives automated call with prompts to answer target questions on schedule pre-selected by patient at initiation of HIYH case; if patient does not answer or respond fully during the automated call, patient will receive a call from an HIYH-trained technician; should patient not respond to this phone call, the patient's family member(s) or caregivers will be notified per the patient's pre-selection of those in their Circle of Care (see description below); Cell phone—allows automatic transmission of data from wearables and other devices provided to patient by HIYH; for other data, patient receives automated call with prompts to answer target questions on schedule pre-selected by patient at initiation of HIYH case; if patient does not answer or respond fully during the automated call, patient will receive a call from an HIYH-trained technician; should patient not respond to this phone call, the patient's family member(s) or caregivers will be notified per the patient's pre-selection of those in their Circle of Care (see description below); Smart phone—allows automatic transmission of data from wearables and other devices provided to patient by HIYH; for other data, patient receives reminder on phone with prompts to respond to target questions on this device on schedule pre-selected by patient at initiation of HIYH case; If patient does not respond within pre-selected time frame, patient will receive automated phone call with prompts to answer target questions on schedule preselected by patient; if patient does not respond or answer questions fully during the automated call, the patient will receive a call from an HIYH-trained technician; If the patient does not respond to this phone call, the patient's family member(s) or caregivers will be notified per the patient's pre-selection of those in their Circle of Care (see description below); Computer or tablet—allows automatic transmission of data from wearables when device has Wi-Fi access and other devices provided to patient by HIYH; HIYH will contract with major cell providers so that computers can transit using cellular data, as well; for other data, patient receives reminder on phone with prompts to respond to target questions on this device on schedule pre-selected by patient at initiation of HIYH case; If patient does not respond within pre-selected time frame, patient will receive automated phone call with prompts to answer target questions on schedule preselected by patient: if patient does not respond or answer questions fully during the automated call, the patient will receive a call from an HIYH-trained technician; If the patient does not respond to this phone call, the patient's family members) or caregivers will be notified per the patient's pre-selection of those in their Circle of Care (see description below). 1.3.1.c. Selection of Circle of Care participants: Patient will select which doctors, nurses, caregivers, family members, and other health professionals will be contacted, and under what circumstances, in order to ensure seamless access to appropriate care and enhanced safety, 1.4. Medications entered—Patient is prompted to enter all medications, including over-the-counter medications, prescription medications, herbal remedies, etc., 1.5. Quality of Life Index—Patient is prompted to indicate a positive goal that will enhance his/her daily functioning and quality of life.

FIG. 2. Initial Monitoring of Symptoms for statistical significance: 2.1 Analyzing response to medication and dose, including side effects, 2.2. Analyzing variability for outliers to identify real, statistically significant change—these actionable items are based on population standards (e.g. blood pressure standards) regardless of the relationship they may have to a medication/dose or treatment. The system detects outliers (change in symptoms, side effects, and quality of life indicators) AND determines the relationship between change and medication dose for that individual patient. HIYH will also be useful for determining the degree to which an individual is experiencing placebo effect. Not only will HIYH find the right drug that works in a particular patient's body; it will also have the capacity to determine, through SSD design, to determine how much of that is due to placebo effect. 2.3 Prompting medically appropriate follow-up if symptoms are at a critical level—data is sent to the doctor's office and may change the patient's previously assigned appointment; if the patient need care prior to the time of the appointment, the Continuum of Care is followed: If appropriate, the patient will be referred to a telemedicine group, urgent care facility, or (when necessary) the emergency room; when this referral is made and the patient's Circle of Care contacted, HIYH prompts the patient to respond once s/he has interacted with the health care professional, who is also contacted by HIYH and any pertinent treatment information is added to the HIYH system for the patient and the updated information is forwarded to she patient's regular doctor and/or Circle of Care participants, as pre-selected by the patient.

FIG. 3. Initial Doctor's Visit: 3.1. Patient receives reminders from HIYH about the appointment date and time and is prompted to bring any wearables or devices provided by HIYH to the doctor's office for calibration. 3.2 Existing baseline data and any treatment that occurred between HIYH case initiation and this visit is reviewed by the doctor or designee. 3.3 Receptionist has HIYH release form for patient and may have additional questions that have been generated by the HIYH system, the doctor, or other health professional. The receptionist refers the patient to a dedicated interactive automated device in the office (provided by HIYH) to respond to these questions, to verify symptoms and medications already entered, and to list any symptoms/medications not already in the system. Should the patient wish, the receptionist (who has been trained by HIYH) can assist with this process or complete this step with the patient. 3.4. Nurse meets with patient, calibrates devices and answers any questions about technology; nurse verifies data, issues, and problems triggered by HIYH data and enters additional vital statistics from this visit. 3.5. Doctor reviews HIYH information and discusses it with the patient; in discussion with the patient, a target for each symptom is set, based on the needs of the patient and the degree to which the symptom interferes with daily functioning (this target will establish the threshold for clinical significance); any prescriptions are submitted electronically to the patient's selected pharmacy through the HIYH system, as entered by the doctor and using a trial/titration dose of the medication: A trial/titration dose is prescribed, rather than the current industry standard of a 30-, 60-, or 90-day supply because, using this system, the doctor and patient will know within a much shorter time frame (as little as three days) and subsequent adjustments can be made quickly and with reduced expense to the patient and third-party payors. 3.6. Designee at doctor's office enters all pertinent information from this doctor's visit are entered into the HIYH system, including medications and potential side effects

FIG. 4. Ongoing Monitoring of Statistically and Clinically Significant Changes in Symptoms: 4.1. Automatic data from wearables and devices continues to be fed into the HIYH system daily and monitored for statistical and clinical significance. 4.2. Patient ratings for ADLs. For each of the pre-selected questions on the patient's daily questionnaire, patient is prompted to rate the symptom on a scale of 1 to 10, using a “slider” that anchors with words to operationalize and therefore standardize the description of the symptom; 4.3. Analyzing response to medication and dose, including side effects—the following protocol will be followed for analysts of clinical and statistical significant. When there is clinically and or statistically significant change, doctor initiates contact with patient and Circle of Care to tell patient to continue this intervention and to continue to complete daily questionnaires for HIYH in order to continue to monitor the response to the dose prescribed; a new or revised target may be set, doctor modifies prescription as necessary or electronically submits longer-term prescription of appropriate dosage of the medication, and after a period of time, the doctor, in consultation with the patient, may decide to decrease the frequency of questionnaires, but the patient is advised to continue monitoring; a new or revised target may be set. If there is improvement after three days but not clinically or statistically significant—doctor notes the improvement in the HIYH system and can choose when to re-evaluate/intervene by changing either the dose or the target for clinical significance, notifies the patient and Circle of Care, as pre-selected by the patient. If there is not clinical or statistical change within three days the doctor can choose whether or not to contact the patient and/or adjust the dosage, enters this in the HIYH system; a new or revised target for clinical significance may be set

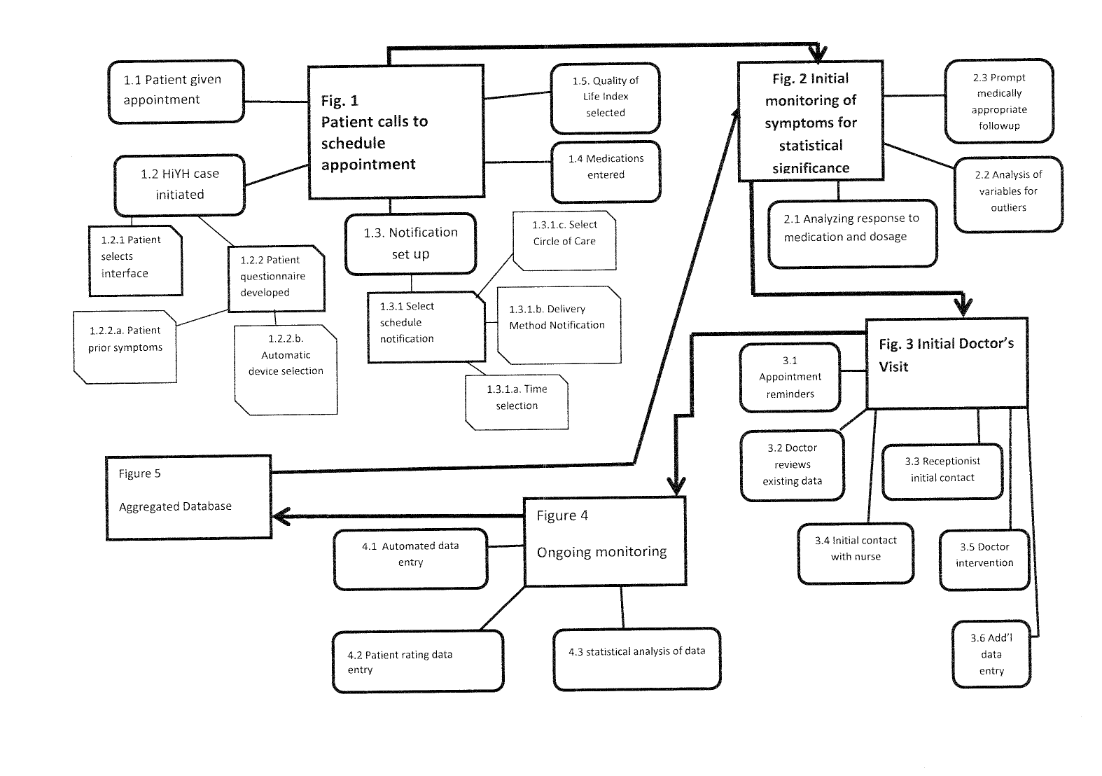

FIG. 5. Aggregated databases; Daily within-patient data becomes part of aggregated, anonymous, longitudinal database that can subsequently be searched using specified demographic information (e.g., gender, age, concomitant diagnosis, polypharmacy, DNA) for predictive value in determination of effective medications and treatments to prescribe. The aggregated database provides predictive data that increases the efficacy of prescriptions for an individual patient who fits certain demographic profile(s), thereby facilitating the prescribing physician's choice and insurance approval for the prescription of a particular medication for that individual patient, the system will automatically generate the appropriate insurance approval forms for each patient.

### SUMMARY, RAMIFICATIONS, AND SCOPE

The invention detailed in this Patent Application is a decision support system that utilizes single system design that determines what real change is for each individual patient, rather than relying on a “one-size-fits most” approach to medical decision-making. While the description of this invention found in this patent application describes a medical application, the decision-making system will be applicable to a wide variety of settings, including service industries, and educational decision-making, as well as personal management and lifestyle enhancement. The system detects outliers (change in symptoms, side effects, and quality of life indicators) in real time AND determines the relationship between change and medication/dose for that individual patient. HiYH will also be useful for determining the degree to which an individual is experiencing placebo effect. Not only will HiYH find the right drug that works in a particular patient's body; it will also have the capacity to determine, through SSD design, to determine how much of that is due to placebo effect. HiYH's proprietary algorithm revolutionizes the “science” of today's medical system in that it determines when statistical significance has been achieved so that real-time change will be captured and analyzed so that whenever true change occurs, actionable alerts will be triggered and all patient-chosen stakeholders will know. This invention dramatically maximizes sensitivity and timeliness of individualized, evidence-based practice while using the very inferential statistics that science has grown and the FDA has used for specificity. Plus, the HiYH system asks the patient to submit genomic testing (or provides it) and anonymously compiles this information and patient data for medications and side effects. This aggregated database will provide predictive data that increases the efficacy of prescriptions for an individual patient who fits certain demographic profile(s), thereby supporting physician decision-making with evidence-based individualized alternative. This is context for medical decision making and selection of appropriate medication. Such an aggregated database has far-reaching implications for determining how a variety of factors (physical, genomic, personality-based, and preference-related, among others) may impact which medication will work best for an individual.

In addition to revolutionizing the science of medicine, it revolutionizes access to care in several ways: First, this system will utilize state-of-the art, yet easily accessible technologies, many of which will transmit data automatically, using WiFi and cellular transmission, provided by the system after negotiation of contracts with major providers for this service, thereby making the current invention more accessible for patients without health insurance and those without internet capabilities in their homes. Use of these technologies allows immediate response and feedback when it is needed and provides seamless access to care. Second, with HiYH doctors will know when a medication is working, when it is not, and when side effects are impactful without waiting for a scheduled appointment. Plus. The system connects the patient, designated caregivers and family members, and health providers (the patient's Circle of Care) whenever there is statistically or clinically significant change rather than waiting for an arbitrarily-scheduled follow-up appointment. Third, the system determines if the patient needs care prior to the time of the appointment and offers coordinated care, offering a continuum of services. If appropriate, the patient will be referred to a telemedicine group, urgent care facility, or (when necessary) the emergency room. Further, HiYH in hospital offers a different form of monitoring that will help even when the expensive hardware and highly trained personnel only available on an inpatient basis are required. The invention, is, therefore, a safety-enhancing, health-optimizing system. Other safety-enhancing, health-optimizing features include HiYH's use of single system design, using within-patient analysis and the proprietary algorithm, along with the ability to pinpoint the correct medication and dosage and monitor symptoms and side effects. Specificity in medication and dosage selection and sensitivity to significant changes and awareness of consequential side effects allows this system to address small problems before those become medical crises. Further, the frequency of the repeated measurements that has previously posed the problem of overwhelming our capacity to evaluate the data has (in this invention) been translated to our being able to replicate measurement (repeat an assessment of out of range values), ensuring safety when the data indicates significant negative change. The system will include observation for interactions in existing medication databases whenever a new medication or supplement is added, flagging medications for refills and communicating with doctor's offices automatically (always with patient choosing these services). When a medication is not working at all (or is plateauing short of target values, providers will have a link to alternative doses, evidence-based practice, and alternative medications related to BOTH the medication used (similar FDA approved drugs for the diagnosis) or the symptoms. This will add efficacy and safety options in the event that the ineffective medication was being tried off-label or will give options for off-label uses that have evidence to support their utility for the specific symptoms. This system pinpoints the right medication and dosage quickly, identifies and addresses consequential side effects rapidly, and precisely informs patients, medical professionals, and other caregivers about significant change when it is time for informed action, thus reducing needless and stressful worsening of symptoms for patients that currently may lead to unnecessary and costly hospitalization and emergency room visits. These factors, plus the use of continuous monitoring, tiered alerts, and intervention prior to the patient being in crisis lead to the system also manifesting dramatic cost savings. Further, assessments based on retrospective recall are notoriously ineffective and inefficient for medical decision-making. HiYH's system eliminates recall bias, more accurately pinpointing the correct medication and dosage, quickly alerting to any necessary medication changes, and identifying medical issues before they become medical crises. In addition, to its statistical significance focus on sensitivity and specificity with biometric data, this invention also targets medical science and third party payor's practical standard of functionality: Activities of Daily Living (ADLs). To determine baseline functioning and prioritize improvement goals, patient and provider collaborate to choose relevant impaired ADLs and improvement goals as part of the system's emphasis on clinical significance and ADLs are analyzed using the same statistical processes as medical symptoms. The system described in this Patent Application empowers patients to maximize personal health and satisfaction. The patient is prompted to indicate a positive goal that will enhance his/her daily functioning and quality of life and set targets for those, offering motivational reinforcement to patients. QoLIs are analyzed using the same statistical processes as medical symptoms. Clinical significance in this system is defined as “what is meaningful to the patient.” Therefore, the system is truly patient-centered, having each patient chooses the symptoms that are disruptive to his/her life and helping the patient monitor, analyze, and report those symptoms immediately, and succinctly to their health-care provider.

In essence, for the physician, this system facilitates delivery of medical care to patients that is timely, sensitive to the patient's preferences, and effectively tuned to the needs of each patient for efficient, optimized medical care. It also provides assistance in optimizing medical care, acting as an “assistant to the expert” system that signals the physician to look at data that are statistically significant so they can best determine what is clinically significant, as determined by the range of possible interventions. For third party payors, this system will, improve patient care, enhance patient wellness, and increase patient satisfaction with their medical providers and system. It will also dramatically reduce costs through efficient tiered contact for the patient with medical system interaction, minimized ER visits and hospitalizations (while facilitating them when appropriate), targeted prescribing information, and efficiency in scheduling medical appointments when medically relevant, necessary, and effective. For patients, HiYH will improve satisfaction and improve quality of life as it provides enhanced safety, quicker recovery, and seamless access to care, while improving their communication with medical professionals, family members, and caregivers. It will coordinate their care based on real needs rather than, arbitrarily determined appointment and will offer a continuum of services while preventing the need for costly hospitalizations or emergency room visits.

1. A decision-support system comprising a single system design (SSD) and a proprietary algorithm that determines what real change is for each individual patient, rather than, relying on a “one-size-fits most” approach to medical decision-making, including pinpointing the right medication and dosage for an individual patient, targeting field standards for functionality, Activities of Daily Living (ADLs), and targeting Quality of Life Indicators (QoLIs) to maximize personal health and satisfaction, through the use of a specified communication system, provision of coordination of services and a continuum of care, and use of machine learning.

2. The SSD analysis system of claim 1 detects outliers (change in symptoms, side effects, and quality of life indicators) in real time AND determines the relationship between change and medication/dose for that individual patient. Doctors can make informed decisions based on data that is analyzed automatically from an array of devices and short “moment” surveys rather than solely on what patients report from memory. The proprietary algorithm and continuous statistical analysis determines when an individual patient's status has statistically varied from his or her individual baseline as the system measures and analyzes whether a medication works in an individual with scientific certainty in real time.

3. The SSD analysis system of claim 1 includes a proprietary algorithm provides the means for revolutionizing the “science” of today's medical system in that it determines when statistical significance has been achieved so that real-time change will be captured and analyzed so that whenever true change occurs, actionable alerts will be triggered and all patient-chosen stakeholders will know. Whereby this invention dramatically maximizes sensitivity and timeliness of individualized, evidence-based practice while using the very inferential statistics that science has grown and the FDA has used for specificity

4. The SSD analysis system of claim 1 incorporates genomic testing and compiles this information and HiYH collected patient data for medications and side effects. Thereby, this aggregated database will provide predictive data that increases the efficacy of prescriptions for an individual patient who fits certain demographic profile(s), thereby supporting physician decision-making with evidence-based individualized alternative. This is context for medical decision making and selection of appropriate medication. Such an aggregated database has far-reaching implications for determining how a variety of factors (physical, genomic, personality-based, and preference-related, among others) may impact which medication will work best for an individual.

5. The SSD analysis system of claim 1 includes data collection is in the form of brief patient-reported survey and biometric data that is collected through automatic integration of device information, utilizing technology which is often wearable, affordable, and easily managed in a home setting. Data collection is tailored to the patient's needs and preference for multi-directional information-sharing with designated family members and professionals, form(s) of data to enter, amount of data to enter, and technology used. The system also allows integration of existing technological applications, including medical interaction applications.

6. The SSD analysis system of claim 1 allows for continuous monitoring of clinically and statistically significant change in symptoms and consequential side effects of medications and treatments, thereby triggering intervention before the onset of crisis events.

7. The SSD analysis system of claim 1 is a safety enhancement system whereby specificity in medication and dosage selection and sensitivity to significant changes and awareness of consequential side effects allows this system to address small problems before those become medical crises. Other safety-enhancing, health-optimizing features include HiYH's use of single system design, using within-patient analysis and the proprietary algorithm, along with the ability to pinpoint the correct medication and dosage and monitor symptoms and side effects. Specificity in medication and dosage selection and sensitivity to significant changes and awareness of consequential side effects allows this system to address small problems before those become medical crises. Further, the frequency of the repeated measurements that has previously posed the problem of overwhelming our capacity to evaluate the data has (in this invention) been translated to our being able to replicate measurement (repeat an assessment of out of range values), ensuring safety when the data indicates significant negative change. The system will include observation for interactions in existing medication databases whenever a new medication or supplement is added, flagging medications for refills and communicating with doctor's offices automatically (always with patient choosing these services). When a medication is not working at all (or is plateauing short of target values, providers will have a link to alternative doses, evidence-based practice, and alternative medications related to BOTH the medication used (similar FDA approved drugs for the diagnosis) or the symptoms. This will add efficacy and safety options in the event that the ineffective medication was being tried off-label or will give options for off-label uses that have evidence to support their utility for the specific symptoms.

8. The SSD analysis system of claim 1 invention improves the connection and flow of information between patients, healthcare providers, caregivers, and family members to improve effectiveness and efficiency of decisions leading to medical intervention. This is a HIPAA compliant communication system with patient-selected family and caregiver notification, featuring seamless communication between patients and physicians through tiered use of trained medical and support professionals.

9. The SSD analysis system of claim 1 will provide tiered alerts to medical professionals and those family members and caregivers designated in advance by the patient, known in this system as the “Circle of Care.” The system features seamless communication between the patient, healthcare providers, and patient-selected family and caregivers. This system empowers each patient to take an active role in maximizing personal health and individual ownership of health care, while connecting family, caregivers, professionals and organizations into a cohesive health care team.

10. The SSD analysis system of claim 1 the system described in this Patent Application empowers patients to maximize functionality, personal health and satisfaction. Utilizing targets of medical science's and third party payors' practical standards of functionality, the patient is prompted to indicate a positive goal that will enhance his/her daily functioning and quality of life and set targets for those, offering motivational reinforcement to patients.

11. The SSD analysis system of claim 1 support revolutionizes access to care in several ways: First, this system will utilize state-of-the art, yet easily accessible technologies, many of which will transmit data automatically, using WiFi and cellular transmission, provided by the system after negotiation of contracts with major providers for this service, thereby making the current invention more accessible for patients without health insurance and those without internet capabilities in their homes. Use of these technologies allows immediate response and feedback when it is needed and provides seamless access to care. Second, with HiYH doctors will know when a medication is working, when it is not, and when side effects are impactful without waiting for a scheduled appointment. Plus, the system connects the patient, designated caregivers and family members, and health providers (the patient's Circle of Care) whenever there is statistically or clinically significant change rather than waiting for an arbitrarily-scheduled follow-up appointment. Third, the system determines if the patient needs care prior to the time of the appointment and offers coordinated care, offering a continuum of services. If appropriate, the patient will be referred to a telemedicine group, urgent care facility, or (when necessary) the emergency room. Further, HiYH in hospital offers a different form of monitoring that will help even when the expensive hardware and highly trained personnel only available on an inpatient basis are required.

12. The SSD analysis system of claim 1 provides a coordination of services and a continuum of care that provides interaction between patient data and a computer generated notification system that, depending on the level of intervention needed, can contact a system provided call center, a caregiver/family member designated by the patient, a trained receptionist in the physician's office, a nurse in the physician's office, and/or the physician. While many very unstable people will actually be better monitored and treated at home on HiYH than at hospital without it, inpatient HiYH will bridge that gap and create a new level of sensitivity and efficiency for intensive inpatient care when needed.

13. The SSD analysis system of claim 1 alerts health providers when significant change indicates it is necessary. By efficiently deciphering layers of data and providing targeted information and context for efficient medical decision-making, the system increases efficiency of the healthcare provider's time. HiYH is the only one system that can manage Big Data so that a patient (and his medical provider (and family, anyone that the patient wants to know), can know with scientific certainty whether a particular medication or intervention works in her/his body in real-time without sifting through copious data and trying to discern patterns that are not based on statistical analysis.

14. The SSD analysis system of claim 1 system pinpoints the right medication and dosage quickly, identifies and addresses consequential side effects rapidly, and precisely informs patients, medical professionals, and other caregivers about significant change when it is time for informed action, thus reducing needless and stressful worsening of symptoms for patients that currently may lead to unnecessary and costly hospitalization and emergency room visits. These factors, plus the use of continuous monitoring, tiered alerts, and intervention prior to the patient being in crisis lead to the system also manifesting dramatic cost savings.

15. The SSD analysis system of claim 1 will determine the degree to which an individual is experiencing placebo effect.

16. The SSD analysis system of claim 1 through machine-learning techniques, will analyze patterns, and modeled and reliable change will be detected that indicate a diagnostic or real change.
